(19) United States
(12) Patent Application Publication
(10) Pub. No.: US 2010/0174614 A1
(43) Pub. Date: Jul. 8, 2010

(54) SYSTEM AND METHOD FOR MANAGING ELECTRONIC SERVICE PLATFORM

(75) Inventor: Chien-Shin Wu, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: CHUNGHWA TELECOM CO., LTD., Taipei (TW)

(21) Appl. No.: 12/394,514

(22) Filed: Feb. 27, 2009

(30) Foreign Application Priority Data
Jan. 5, 2009 (TW) 098100012

(51) Int. Cl. G06Q 10/00; G06Q 30/00

(52) U.S. Cl. 705/21; 705/30; 705/26

(57) ABSTRACT

Provided are a system and a method for managing an electronic service platform, which are applicable to a network communication architecture including a server end, a user end, and a POS terminal. The method includes: logging in, by the user end, a common service platform provided at the server end; editing commodity sale information and/or POS terminal identification data through an editing interface provided by the common service platform; converting, by the server end, the edited commodity sale information into a POS terminal compatible file format according to a POS terminal type; and finally transmitting the converted commodity sale information to the POS terminal for display such that clients can place commodity orders via the POS terminal, thereby reducing production and usage costs of the electronic service platform.

### BACKGROUND OF THE INVENTION

1. Field of the Invention

The present invention relates generally to common platform management techniques, and more particularly to a system and a method for managing an electronic service platform that provides customized processing.

2. Description of Related Art

Owing to the rapid development of wireless network techniques, the application of POS (Point of Sale) systems is no longer limited to the communication industries, but has expanded to retailing services such as catering. For example, a waiter or a client can enter order information into a portable wireless communication terminal. The order information entered is then transmitted to an order information processing system by the wireless communication terminal, and further transmitted to a printer apparatus by the order information processing system so as to print out the order. The order information is also transmitted to a terminal provided in the kitchen such that cooking is performed according to the order content. After the meal, settlement of payment can be made at a POS terminal. Such a method improves the operation efficiency of restaurants, enhancing the service and management quality and therefore becomes quite popular.

However, most of POS terminal order systems are customized systems, that is, their system programs are separately compiled according to various demands of catering enterprises. Therefore, besides software and hardware costs incurred in customized management systems, catering enterprises also pay for maintenance costs, and the systems also have to be periodically examined by professional IT staffs. For small catering businesses, especially family-run businesses, these additional costs become a big burden that prevents them from adopting electronic management modes.

Therefore, the present invention is directed to an issue, that is, providing a low cost system and method for managing an electronic service platform so as to meet small and medium retailers' application needs.

### SUMMARY OF THE INVENTION

In view of the above drawbacks, an object of the present invention is to provide a system and a method for managing an electronic service platform so as to greatly reduce production and usage costs of current POS terminal transaction management systems, thereby meeting small and medium retailers' application needs.

Another object of the present invention is to provide a system and a method for managing an electronic service platform whereby users can design commodity sale information displayed by a POS terminal according to their own preferences.

In order to achieve the above and other objects, the present invention provides a system for managing an electronic service platform, which is applicable to a network communication architecture comprising a server end, a user end and a POS terminal. The system comprises: a login module through which the user end logs in a common service platform provided at the server end; an editing module for editing commodity sale information and/or POS terminal identification data through a common editing interface provided by the common service platform and storing the edited commodity sale information and/or POS terminal identification data; and a converting module for converting the edited and stored commodity sale information into a POS terminal compatible file format according to a POS terminal type contained in the POS terminal identification data, the converted commodity sale information being further transmitted to the POS terminal according to a POS terminal network address contained in the POS terminal identification data for display, thereby allowing clients to place orders by entering commodity order information into the POS terminal. The system further comprises a statistics module for performing a statistical analysis of commodity order information sent from the POS terminal to the server end and for processing inquiry made by the user end having logged in the common service platform regarding the statistical analysis result.

The present invention further provides a method for managing an electronic service platform, which is applicable to a network communication architecture comprising a server end, a user end and a POS terminal. The method comprises the steps of: the user end logging in a common service platform provided at the server end; editing commodity sale information and/or POS terminal identification data through a common editing interface provided by the common service platform and storing the edited commodity sale information and/or POS terminal identification data; the server end converting the edited commodity sale information into a POS terminal compatible file format according to a POS terminal type contained in the POS terminal identification data; and transmitting the converted commodity sale information from the server end to the POS terminal according to a POS terminal network address contained in the POS terminal identification data such that the POS terminal displays the corresponding commodity sale information, thereby allowing clients to place orders with the POS terminal. The method further comprises a step of transmitting commodity order information entered into the POS terminal to the server end such that the server end can perform a statistical analysis of the commodity order information and the statistical analysis result can be inquired by the user end having logged in the common service platform.

Therefore, the present invention provides a common service platform through which users can design and edit a layout of commodity sale information. Then, the edited commodity sale information layout is converted to a POS terminal compatible file format according to a POS terminal type and further transmitted to the POS terminal for display, thereby allowing clients to place orders with the POS terminal. Therefore, the present invention greatly reduces the production and usage costs of POS terminal transaction management systems and accordingly meets small and medium retailers' application requirements. In addition, the present invention allows users to design commodity sale information to be displayed by the POS terminal according to the user's preferences for commodity sale.

### BRIEF DESCRIPTION OF DRAWINGS

FIG. 1 is a diagram showing a network communication architecture to which a system for managing an electronic service platform of the present invention is applicable;

FIG. 2(A) is a block diagram showing the basic structure of a system for managing an electronic service platform according to an embodiment of the present invention;

FIG. 2(B) is a block diagram showing the basic structure of a system for managing an electronic service platform according to another embodiment of the present invention; and

FIG. 3 is a flow diagram showing a method for managing an electronic service platform of the present invention.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification.

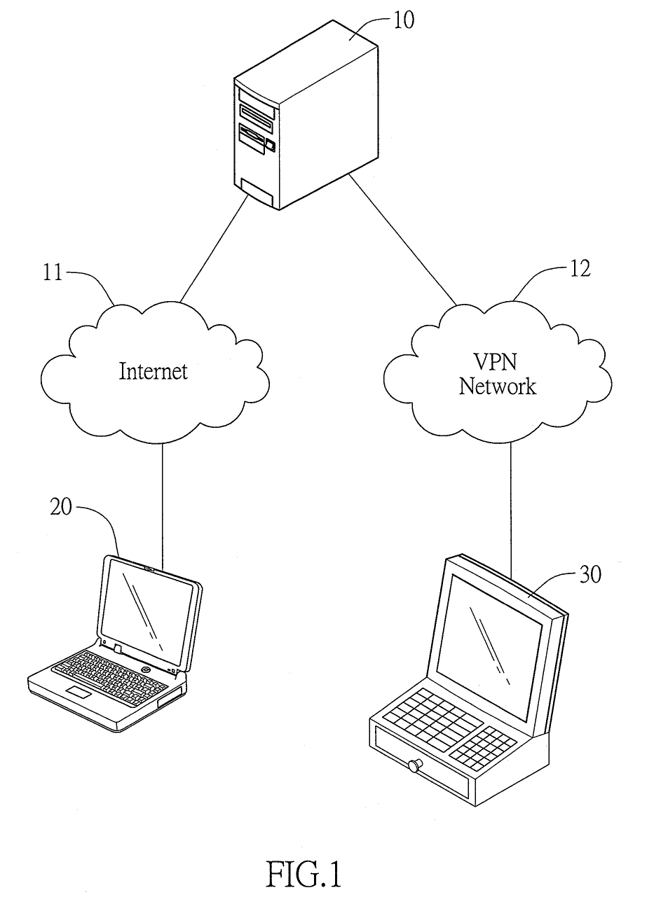

FIG. 1 shows a network communication architecture to which a system 1 for managing an electronic service platform of the present invention is applicable. In the present embodiment, the system 1 is built in a network communication architecture comprising a server end 10, a user end 20 and a POS terminal 30. The server end 10 is a workstation, for example. The user end 20 is, for example, a personal computer or a notebook computer, which is connected to the server end 10 through the Internet 11. The POS terminal 30 is connected to the server end 10 through a virtual private network (VPN) 12. The server end 10 allows users at the user end 20 to edit required commodity sale information, and then the server end 10 sends the edited commodity sale information to the POS terminal 30. The system 1 applies to small and medium retailers. The following description is about a catering entrepreneur who is a user of the system 1. The description merely serves an illustrative purpose.

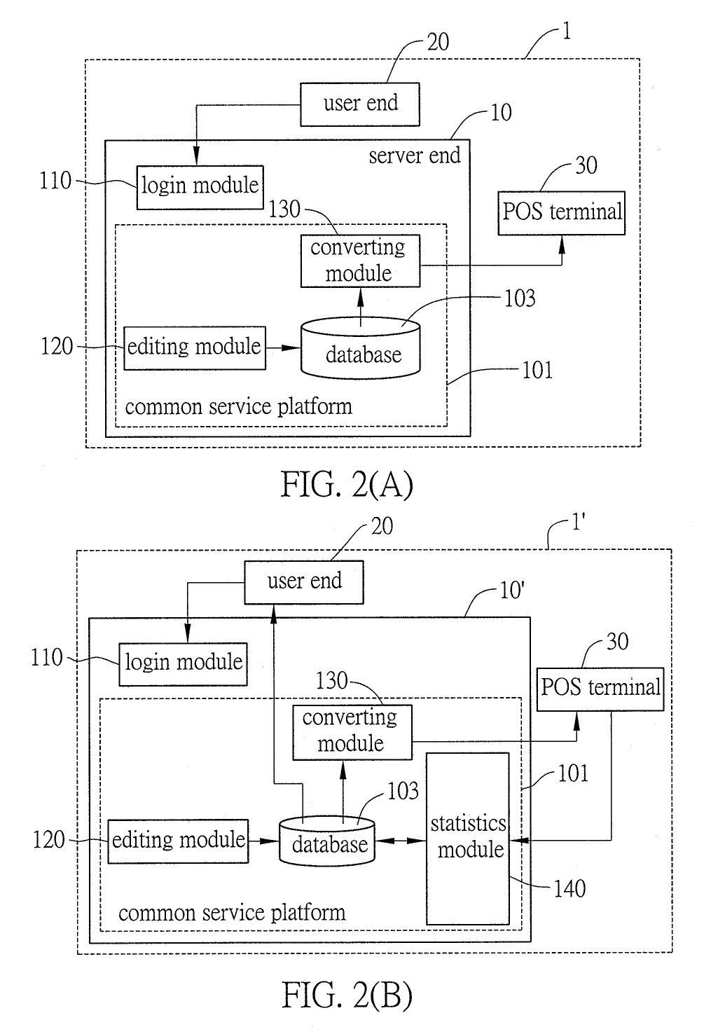

FIG. 2(A) shows the basic structure of the system 1 for managing an electronic service platform. In the present embodiment, the system 1 comprises a login module 110, an editing module 120 and a converting module 130.

The login module 110 allows users at the user end 20 to log in a common service platform 101 at the server end 10 through the Internet 11. The login module 110 further verifies identity of the users logging in the common service platform 101. That is to say, the login module 110 analyzes the users' authority according to user identification information entered into the user end 20, such as user accounts and login passwords. In the present embodiment, the login module 110 determines whether a user has the authority to edit commodity sale information according to identification information entered into the user end 20.

The common service platform 101 provides a common editing interface (not shown) for the editing module 120 according to users. The editing module 120 allows users to edit related commodity sale information through the user end 20 and the common editing interface. For example, the editing module 120 allows the catering entrepreneur to edit related menu information. In the present embodiment, the content to be edited comprises commodity names, descriptions, pictures and so on. In addition, the editing module 120 provides a display layout such that users can edit the layout of the commodity sale information. The editing module 120 further stores the edited commodity sale information in a database 103.

To render the server end 10 capable of identifying the POS terminal 30 that receives the edited commodity sale information, the editing module 120 provides identification data of the POS terminal such as a network address and type of the POS terminal.

The converting module 130 converts the edited commodity sale information into a POS terminal compatible file format according to a POS terminal type contained in the POS terminal identification data, and the server end 10 transmits the converted commodity sale information to the POS terminal 30 according to the POS terminal network address contained in the POS terminal identification data. Thereby, the commodity sale information is displayed on the screen of the POS terminal 30 such that clients can place orders by entering commodity order information into the POS terminal 30. In particular, after a user at the user end 20 logs in the common server platform 101, the user enters related identification data for identifying the POS terminal 30 such as a network address, type, store code, manager code, POS terminal code and so on so as to allow the common service platform 101 to identify the POS terminal 30 to be used by the user, thereby allowing the converting module 130 to convert edited and stored menu data into a POS terminal compatible file format according to a POS terminal type contained in the identification data. Thereafter, the converted menu data stored at the server end 10 is sent to the POS terminal 30 such that clients can place orders according to the menu information displayed on the POS terminal 30. In addition, the order information entered into the POS terminal 30 can be printed out by a wireless high speed printer such that cooking can be performed according to the order content printed out.

FIG. 2(B) shows a system 1′ for managing an electronic service platform according to another embodiment of the present invention. Different from FIG. 2(A), the server end 10′ of the system 1′ further comprises a statistics module 140 for performing a statistical analysis of the commodity order information sent from the POS terminal 30 to the server end 10′. Further, the statistical analysis result can be inquired by users having logged in (via the user end 20) the common service platform provided by the server end 10′. For example, the POS terminal 30 calculates expenses according to the order information entered so as to facilitate the payment settlement after clients have finished their meals. On the other hand, data related to the expense calculation by the POS terminal 30 can be transmitted to the server end 10′ such that a statistical analysis can be performed based on the information, and in consequence monthly reports or annual reports can be created and stored in the database 103. The catering entrepreneur can log in the common service platform 101 through the user end 20 so as to access related statistical information in the database 103 for reference, thereby allowing the catering entrepreneur to better understand the operation of the restaurant and improve the management efficiency.

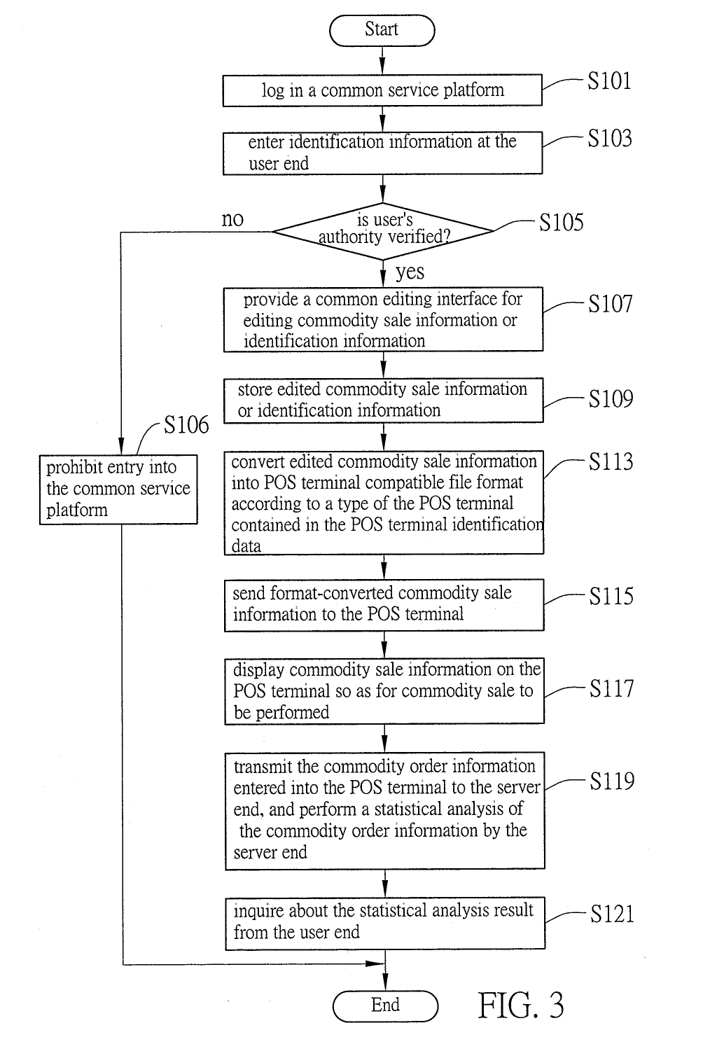

FIG. 3 is a flow diagram showing a method for managing an electronic service platform according to the present invention. First, at step S101, a user end is connected to a server end through the Internet such that a user can log in a common service platform provided by the server end through the user end. Then, the process goes to step S103.

At step S103, the user enters user identification information such as user account and login password through the user end. Then, the process goes to step S105.

At step S105, the user's authority is verified against the entered user identification information. In the present embodiment, the user's authority to edit commodity sale information is determined according to the entered user identification information. Upon completion of verification of the user's authority, the process goes to step S107, otherwise, the process goes to step S106.

At step S 106, the user whose authority is not verified is prohibited from accessing the common service platform, and the process of the method for managing the electronic service platform of the present invention is ended.

At step S107, the common service platform provides a common editing interface through which the user can edit related commodity sale information through the user end. For example, the common service platform provides an editing interface through which the catering entrepreneur can edit the menu content and the layout of the menu content. Also, the catering entrepreneur enters into the user end positioned proximate thereto menu-receiving-POS terminal-related information, such as a network address, type, store code, manager code, POS terminal code, etc., and thus the common service platform 101 is capable of identifying the POS terminal which the catering entrepreneur wants to operate. Then, the process goes to step S109.

At step S109, the edited commodity sale information is stored in the database. Then, the process goes to step S113.

At step S113, the server end converts the edited commodity sale information into a POS terminal compatible file format according to the type of the POS terminal. Then, the process goes to step S115.

At step S115, the converted menu data stored in the server end is sent to the POS terminal. Then, the process goes to step S117.

At step S117, the corresponding commodity sale information is displayed on a display screen of the POS terminal such that clients can place orders with the POS terminal. For example, the menu content is displayed on the display screen of the POS terminal for clients to place orders, and the order information is printed out by a high speed wireless printer such that cooking can be performed in the kitchen according to the printed order information. Then, the process goes to step S119.

At step S119, the commodity order information entered into the POS terminal is transmitted to the server end, and the server end performs a statistical analysis of the commodity order information. Then, the process goes to step S121.

At step S121, from the user end, the user logs in the common service platform provided by the user end, so as to inquire about the statistical analysis result.

Therefore, with the system and method for managing an electronic service platform of the present invention, a common service platform is built at the server end such that a user can edit related commodity sale information through an editing interface provided by the platform, and the edited commodity sale information is converted according to the type of the POS terminal and sent to the POS terminal for display. As a result, clients can place orders with the POS terminal. According to the present invention, not only can users design commodity sale information displayed at the POS terminal according to their own preferences, but the production and usage costs of the POS terminal transaction management systems are greatly reduced, thereby meeting small and medium retailers' application requirements.

The above-described descriptions of the detailed embodiments are only to illustrate the preferred implementation according to the present invention, and it is not to limit the scope of the present invention, Accordingly, all modifications and variations completed by those with ordinary skill in the art should fall within the scope of present invention defined by the appended claims.

What is claimed is:

1. A system for managing an electronic service platform, which is applicable to a network communication architecture comprising a server end, a user end and a POS terminal, the system comprising:
a login module through which the user end logs in a common service platform provided at the server end;
an editing module for editing commodity sale information and/or POS terminal identification data through a common editing interface provided by the common service platform and storing the edited commodity sale information and/or POS terminal identification data; and
a converting module for converting the edited and stored commodity sale information into a POS terminal compatible file format according to a POS terminal type contained in the POS terminal identification data, the format-converted commodity sale information being further transmitted from the server end to the POS terminal according to a POS terminal network address contained in the POS terminal identification data such that the POS terminal displays the corresponding commodity sale information.

2. The system of claim 1, further comprising a statistics module for performing a statistical analysis of commodity order information sent from the POS terminal to the server end and for processing inquiry made about the statistical analysis result by the user end having logged in the common service platform.

3. The system of claim 2, wherein the POS terminal is connected to the server end through a virtual private network (VPN) for transmitting data and information to the server end.

4. The system of claim 1, wherein the user end logs in the common service platform at the server end through the Internet.

5. The system of claim 1, wherein the editing module displays a layout of the entered commodity sale information and enables editing of the layout thereof.

6. The system of claim 1, wherein the login module verifies a user's authority according to user identification information entered by the user through the user end.

7. A method for managing an electronic service platform, which is applicable to a network communication architecture comprising a server end, a user end and a POS terminal, the method comprising the steps of:
(1) logging in, by the user end, a common service platform provided at the server end;
(2) editing commodity sale information and/or POS terminal identification data through a common editing interface provided by the common service platform and storing the edited commodity sale information and/or POS terminal identification data;
(3) converting, by the server end, the edited commodity sale information into a POS terminal compatible file format according to a POS terminal type contained in the POS terminal identification data; and
(4) transmitting the converted commodity sale information from the server end to the POS terminal according to a POS terminal network address contained in the POS terminal identification data such that the POS terminal displays the corresponding commodity sale information.

8. The method of claim 7, further comprising a step (5) of transmitting commodity order information entered into the POS terminal to the server end such that the server end performs a statistical analysis of the commodity order information and the statistical analysis result can be inquired by the user end having logged in the common service platform.

9. The method of claim 8, wherein the POS terminal is connected to the server end through a virtual private network (VPN).

10. The method of claim 7, wherein the user end logs in the common service platform at the server end through the Internet.

11. The method of claim 7, wherein step (2) further comprises displaying layout of the commodity sale information for editing.

12. The method of claim 7, wherein step (1) further comprises verifying the user's authority according to user identification information entered by the user through the user end.
